(19) United States
(12) Patent Application Publication
(10) Pub. No.: US 2025/0011994 A1
(43) Pub. Date: Jan. 9, 2025

(54) METHOD OF LAUNDERING FABRIC

(71) Applicant: The Procter & Gamble Company, Cincinnati, OH (US)

(72) Inventors: Alan Thomas BROOKER, NEWCASTLE UPON TYNE (GB); Lindsey HEATHCOTE, NORTHUMBERLAND (GB); Karolina Anna KORZYCKA, GATESHEAD (GB); Andrew Philip MOON, NEWCASTLE UPON TYNE (GB)

(21) Appl. No.: 18/757,920

(22) Filed: Jun. 28, 2024

(30) Foreign Application Priority Data
Jun. 28, 2023 (EP) 23182159.6

(51) Int. Cl. D06F 35/00; C11D 3/00; C11D 3/20; D06L 1/16; D06L 1/20

(52) U.S. Cl. CPC D06F 35/006; C11D 3/0047; C11D 3/2086; D06L 1/16; D06L 1/20; C11D 2111/12; C11D 2111/44

(57) ABSTRACT

The present invention relates to a method of laundering fabric. The method subjects the fabric to be laundered to an acidic washing step. Following the acidic washing step, the fabric is removed from the acidic wash bath and subjected to a total abrasive force of from 1.5 kg to 10 kg. The fabric is then rinsed with water.

### FIELD OF THE INVENTION

The present invention relates to a method of laundering fabric. The method subjects the fabric to be laundered to an acidic washing step. Following the acidic washing step, the fabric is removed from the acidic wash bath and subjected to a specific total abrasive force. The fabric is then rinsed in water.

### BACKGROUND OF THE INVENTION

Detergent manufacturers seek to provide products that have good cleaning performance as well as good fabric care performance. Reducing the pH profile of the product is one way detergent manufacturers can improve the fabric care performance of the product. Typical solid laundry detergent products have a pH of ˜10.5, reducing that pH profile right down to a pH of 2-3 can significantly improve the fabric care profile. However, reducing the pH profile to be so acidic can significantly skew the cleaning profile of the product, especially the removal of complex coloured soils such as underarm soils.

The present invention seeks to provide a method of laundering fabric that provides both good fabric care performance and good cleaning performance, especially for the removal of complex coloured soils. The present invention provides a method that involves the acidic soaking of the soiled fabric in a controlled dose and volume and at very low pH, followed by the removal of the soiled fabric from the soak and subjecting the fabric to a specific total abrasive force, followed by a rinsing step.

The process of the present invention provides good fabric care as well as good fabric cleaning against complex coloured soils.

### SUMMARY OF THE INVENTION

The present invention provides a method of laundering fabric wherein the method comprises the steps:
(a) contacting from 10 g to 100 g of an acidic solid laundry detergent composition to from 1.01 L to 10.0 L of water to form an acidic aqueous wash bath having a pH in the range of from 2.0 to 3.0,
   wherein the acidic solid laundry detergent composition comprises from 10 wt % to 70 wt % acidic component, and from 1.0 wt % to 20 wt % detersive surfactant;
(b) contacting soiled fabric to the acidic aqueous wash bath, and washing the soiled fabric in the acidic aqueous wash bath for from 20 mins to 24 hours,
(c) removing the washed fabric from the acidic aqueous wash bath;
(d) subjecting the soiled fabric, from step (c) to a total abrasive force of from 1.5 kg to 10 kg; and
(e) rinsing the washed fabric with water.

### DETAILED DESCRIPTION OF THE INVENTION

### Method of Laundering Fabric

The method comprises the steps:
(a) contacting from 10 g to 100 g of an acidic solid laundry detergent composition to from 1.01 L to 10.0 L of water to form an acidic aqueous wash bath having a pH in the range of from 2.0 to 3.0,
   wherein the acidic solid laundry detergent composition comprises from 10 wt % to 70 wt % acidic component, and from 1.0 wt % to 20 wt % detersive surfactant;
(b) contacting soiled fabric to the acidic aqueous wash bath, and washing the soiled fabric in the acidic aqueous wash bath for from 20 mins to 24 hours,
(c) removing the washed fabric from the acidic aqueous wash bath;
(d) subjecting the soiled fabric, from step (c) to a total abrasive force of from 1.5 kg to 10 kg; and
(e) rinsing the washed fabric with water.

### Step (a) Forming an Acidic Aqueous Wash Bath

Step (a) contacts from 10 g to 100 g of an acidic solid laundry detergent composition to from 1.01 L to 10.0 L of water to form an acidic aqueous wash bath having a pH in the range of from 2.0 to 3.0. The acidic solid laundry detergent composition comprises from 10 wt % to 70 wt % acidic component, and from 1.0 wt % to 20 wt % detersive surfactant.

### Step (b) Acidic Washing Step

Step (b) contacts the soiled fabric to the acidic aqueous wash bath, and washes the soiled fabric in the acidic aqueous wash bath for from 20 mins to 24 hours.

Preferably, during step (b) the soiled fabric is washed in the acidic aqueous wash bath for from 30 mins to 3 hours.

Preferably, step (b) is carried out with an acidic aqueous wash bath temperature of 5° C. to 25° C.

### Step (c) Removing the Washed Fabric

Step (c) removes the washed fabric from the acidic aqueous wash bath.

### Step (d) Abrasive Step

Step (d) subjects the soiled fabric, from step (c) to a total abrasive force of from 1.5 kg to 10 kg.

Preferably, during step (d) the soiled fabric is subjected to a total abrasive force of from 2.0 kg to 6.0 kg.

### Step (e) Rinsing the Washed Fabric

Step (e) rinses the washed fabric with water.

### Acidic Solid Laundry Detergent Composition

The acidic solid laundry detergent composition comprises from 10 wt % to 70 wt % acidic component, and from 1.0 wt % to 20 wt % detersive surfactant.

Preferably, the acidic solid laundry detergent composition from 30 wt % to 70 wt % acidic component, and from 3.0 wt % to 10 wt % detersive surfactant.

### Acidic Component

Any suitable acidic component can be used.

A suitable acidic component is a polycarboxylic acid.

A preferred acidic component is citric acid.

### Detersive Surfactant

Any suitable detersive surfactant can be used.

A suitable detersive surfactant is selected from: alkyl benzene sulphonate, alkyl sulphate, alkoxylated alkyl sulphate, alkoxylated alcohol and any combination thereof.

Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Anionic detersive surfactant: Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Non-ionic detersive surfactant: Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₀-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Cationic detersive surfactant: Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

Zwitterionic detersive surfactant: Suitable zwitterionic detersive surfactants include amine oxides and/or betaines.

Polymer: Suitable polymers include carboxylate polymers, soil release polymers, anti-redeposition polymers, cellulosic polymers, care polymers and any combination thereof.

Carboxylate polymer: The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II): formula (I):

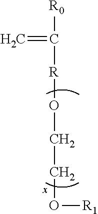

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

formula (II)

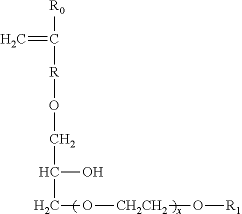

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

Soil release polymer: The composition may comprise a soil release polymer. A suitable soil release polymer has a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-Cis alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Anti-redeposition polymer: Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO08/007320.

A suitable polyethylene glycol polymer is Sokalan HP22.

Cellulosic polymer: Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

Care polymers: Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Bleach: Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of hydrogen peroxide: Suitable sources of hydrogen peroxide include sodium perborate and/or sodium percarbonate.

Bleach activator: Suitable bleach activators include tetra acetyl ethylene diamine and/or alkyl oxybenzene sulphonate.

Bleach catalyst: The composition may comprise a bleach catalyst. Suitable bleach catalysts include oxaziridinium bleach catalysts, transistion metal bleach catalysts, especially manganese and iron bleach catalysts. A suitable bleach catalyst has a structure corresponding to general formula below:

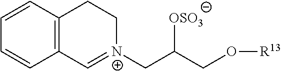

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-formed peracid: Suitable pre-form peracids include phthalimido-peroxycaproic acid.

Enzymes: Suitable enzymes include lipases, proteases, cellulases, amylases and any combination thereof.

Protease: Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz PR series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3R, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the folowing mutations S99D+S101R+S103A+V1041+G159S, hereinafter referred to as BLAP), BLAP R(BLAP with S3T+V41+V199M+V2051+L217D), BLAP X(BLAP with S3T+V41+V2051) and BLAP F49 (BLAP with S3T+V41+A194P+V199M+V2051+L217D) all from Henkel/Kemira; and KAP (Bacillus alkalophilus subtilisin with mutations A230V+S256G+S259N) from Kao.

A suitable protease is described in WO11/140316 and WO11/072117.

Amylase: Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO06/002643.

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carczyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

Lipase: Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g. as described in WO2013/171241; and TfuLip2, e.g. as described in WO2011/084412 and WO2013/033318.

Other enzymes: Other suitable enzymes are bleaching enzymes, such as peroxidases/oxidases, which include those of plant, bacterial or fungal origin and variants thereof.

Commercially available peroxidases include Guardzyme® (Novozymes A/S). Other suitable enzymes include choline oxidases and perhydrolases such as those used in Gentle Power Bleach™

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Zeolite builder: The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

Phosphate builder: The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

Carbonate salt: The composition may comprise carbonate salt. The composition may comprise from 0 wt % to 10 wt % carbonate salt, or to 5 wt % carbonate salt. The composition may even be substantially free of carbonate salt; substantially free means “no deliberately added”. Suitable carbonate salts include sodium carbonate and sodium bicarbonate.

Silicate salt: The composition may comprise silicate salt. The composition may comprise from 0 wt % to 10 wt % silicate salt, or to 5 wt % silicate salt. A preferred silicate salt is sodium silicate, especially preferred are sodium silicates having a Na₂O:SiO₂ ratio of from 1.0 to 2.8, preferably from 1.6 to 2.0.

Sulphate salt: A suitable sulphate salt is sodium sulphate.

Brightener: Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol [1,2-d]triazole, disodium 4,4′-bis {[(4-anilino-6-(N methyl-N-2 hydroxyethyl)amino 1,3,5-triazin-2-yl)];amino}stilbene-2-2′ disulfonate, disodium 4,4′-bis {[(4-anilino-6-morpholino-1,3,5-triazin-2-yl)|amino}stilbene-2-2′ disulfonate, and disodium 4,4′-bis(2-sulfostyryl) biphenyl. A suitable fluorescent brightener is C.I. Fluorescent Brightener 260, which may be used in its beta or alpha crystalline forms, or a mixture of these forms.

Chelant: The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Hueing agent: Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hucing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hucing agents can be incorporated into hueing dye particles, such as described in WO 2009/069077.

Dye transfer inhibitors: Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Perfume: Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (c) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

Silicone: Suitable silicones include polydimethylsiloxane and amino-silicones. Suitable silicones are described in WO05075616.

### Method of Measuring Total Abrasive Force

Abrasive force from hand scrubbing was determined using Swissatest Poka-Dot® test fabric. This fabric allows the measure of abrasive force in washing process by measuring the loss of dots after a force is applied to the fabric. Dot removal can then be quantified by visual scale or by a digital system imaging/analysis program.

We created a known force calibration curve using the test fabric, which enabled a correlation to consumer hand wash abrasive forces.

### EXAMPLES

### Example—Complex Coloured Stain Removal with Soak & Force

Two laundry detergent compositions (Compositions 1 and 2) were made and tested as detailed herein below.

### Test Method

### I. Preparation of Test Compositions

Tests were carried out using the following detergent compositions: Material additions shown at active material level in (g).

Level (g/dose)
Composition

| Ingredient | Composition 1 | Composition 2 |
|---|---|---|
| MCAS | 2.9624 | 2.9624 |
| Non-ionic (C45AE7) | 0.6322 | 0.6322 |
| Citric Acid | 30.0028 | 30.0028 |
| Zeolite | 2.0000 | 2.0000 |
| Buffer (carbonate) | 0.0000 | 30.0000 |
| Sodium Sulphate | 13.0924 | 13.0924 |
| Sodium Chloride | 0.1313 | 0.1313 |
| HEDP | 0.3184 | 0.3184 |
| Perfume | 0.2282 | 0.2282 |
| Process aids, water & misc | 0.6323 | 0.6323 |
| Total | 50 g | 80 g |

### II. Test Procedure

| | | |
|---|---|---|
| Soak Equipment | Plastic 5 L bucket | |
| Soak Volume | 3 L | |
| Soak time | 1 hour | |
| Implement | Hand brush | 8 × 2.5 cm bristle area |
| | | 96 bunches of bristles |
| | | ~1 cm length |
| | | Wooden handle |
| | | 50 g weight |
| Force | 0/ 3 kg | Standard weights |
| Water Hardness | ~6 gpg | Soak & rinse |
| Water Temperature | 25° C. | Soak & rinse |
| Detergent addition | See above | Wash liquor formed from Composition 1 |
| | | pH = 2.7 |
| | | Wash liquor formed from Composition 2 |
| | | pH = 10.0 |
| Complex-colored stains | Lab made | See protocol below |
| Drying equipment | Ambient | Overnight, open bench |
| Spectrophotometer | Konica Minolta | Colorimetric measure in UV adjusted D65 |
| | | lighting conditions. Large aperture. |

### III. Preparation of Complex-Colored Stains for Testing

a. Pre-Conditioning

Swatches of 10 cm×10 cm of 100% Knitted Cotton should be desized/stripped.

Swatches are then washed for 4×40 C Cotton Short (Miele 1714) cycles with Ariel Colour liquid (35 g).

b. Artificial Sweat

| Raw Material: | Activity | % Stock: |
|---|---|---|
| DI Water | 100.00% | 99.05% |
| NaCl | 99.50% | 0.32% |
| Na2CO3 | 100.00% | 0.14% |
| KOH | 87.60% | 0.03% |
| Urea | 100.00% | 0.20% |
| Lactic Acid | 86.80% | 0.21% |
| NH4OH | 30.00% | 0.05% |
| Total: | | 100.00% |

Store in a refrigerated environment for up to 1 week.
1. At room temperature
2. Pour 35 mL of sweat into beaker.
3. Whilst monitoring the pH, add sufficient concentrated HCl dropwise until a pH of 5.5 is achieved.
4. Add 0.02 mL of Bovine Serum Albumin (stored in fridge). Mix well.
5. Cover with aluminium foil and set aside until needed.
   c. Artificial Sebum

| Raw material | % Stock |
|---|---|
| Tripalmitin | 15.00% |
| Triolein | 9.00% |
| Palmitic acid | 13.00% |
| Oleic acid | 13.00% |
| Palmityl palmitate | 8.34% |
| Ethyl oleate | 16.66% |
| Cholesterol | 5.00% |
| Squalene | 20.00% |
| Total: | 100.00% |

Store in glass jar in a refrigerated environment for us to 3 months.

Prior to use take out more sebum than you will need and heat at 55 C in water bath until liquid.

d. Deodorant

Purchase a supply of Gillette Cool Wave deodorant gel.

e. Stain Creation

Per stain Swatch you apply: 1 g deodorant, 1.2 ml sweat, 0.172 ml sebum.

Start
1. Spread 1 g of sebum and antiperspirant mixture directly to the swatch with a paintbrush using a stencil with 5.0 cm round aperture to make a circular stain.
2. Pipette sweat onto the centre of swatch, concentrate sweat on previously applied stain mixture.
3. After 1 hour store at 55 C and 70RH overnight.

### Day 2

1. Remove stains from oven.
2. Wash stains in a 40 C Cotton Short cycle in Miele 1714 with 35 g Ariel Colour liquid & 3 kg ballast. Include 1.5 WFK SBL2004 sheets per wash per 25 stains.
3. Dry on low heat for 30 minutes in gas dryer.
4. Repeat Day 1 stain application procedure.

### Day 3 & 4

1. Repeat Day 2 procedure.

### Day 5

1. Wash stains as above. Stains are now ready for use.

### IV: Soak/Force/Rinse/Dry:

Dissolve test compositions (1) and (2) in 3 L water for 30 seconds via mixing by hand. Add the complex-coloured stains to the soak conditions with the appropriate product. Each stain was then subjected to either a 0.05 or 3.05 Kg force.

Weight was applied on top of the brush, above the stain swatch. The weighted brush was then moved across the stain surface from left to right in one single motion to cover the whole stain.

One additional test leg was also executed, with the absence of any soak and where test composition (1) was used only to wet the stains before the force step was applied. All stains were then rinsed in fresh water, before being left in ambient conditions to dry overnight.

After drying the complex-coloured stains were all measured via spectrophotometer. Results below show the measured WI CIE for all replicates.

### V: Results:

| | WI CIE for complex-coloured stains | | | |
|---|---|---|---|---|
| | | Test A | Test B | Test C |
| Force | Replicate | No soak / Composition 1 | Soak /Composition 1 | Soak / Composition 2 |
| 0.05 Kg | 1 | 97.45 | 98.89 | 95.08 |
| | 2 | 98.78 | 102.33 | 95.82 |
| | Average | 98.12 | 100.61 | 95.45 |
| | St Dev | 0.94 | 2.43 | 0.52 |
| | Difference | Reference | 2.49 | −2.67 |
| | | 2.67 | 5.16 | Reference |
| 3.05 Kg | 1 | 91.57 | 106.38 | 95.79 |
| | 2 | 94.14 | 103.57 | 99.09 |
| | Average | 92.86 | 104.98 | 97.44 |
| | St Dev | 1.82 | 1.99 | 2.33 |
| | Difference | Reference | 12.12 | 4.58 |
| | | −4.58 | 7.54 | Reference |

The example demonstrates the efficacy of composition 1, to deliver improved complex-coloured soil removal with a soak and force of >0.05 Kg.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric wherein the method comprises the steps:
(a) contacting from about 10 g to about 100 g of an acidic solid laundry detergent composition to from about 1.01 L to about 10.0 L of water to form an acidic aqueous wash bath having a pH in the range of from about 2.0 to about 3.0,
wherein the acidic solid laundry detergent composition comprises from about 10 wt % to about 70 wt % acidic component, and from about 1.0 wt % to about 20 wt % detersive surfactant;
(b) contacting soiled fabric to the acidic aqueous wash bath, and washing the soiled fabric in the acidic aqueous wash bath for from about 20 mins to about 24 hours,
(c) removing the washed fabric from the acidic aqueous wash bath;
(d) subjecting the soiled fabric, from step (c) to a total abrasive force of from about 1.5 kg to about 10 kg; and
(e) rinsing the washed fabric with water.

2. A method according to claim 1, wherein during step (d) the soiled fabric is subjected to a total abrasive force of from about 2.0 kg to about 6.0 kg.

3. A method according to claim 1, wherein the acidic solid laundry detergent composition from about 30 wt % to about 70 wt % acidic component, and from about 3.0 wt % to about 10 wt % detersive surfactant.

4. A method according to claim 1, wherein during step (b) the soiled fabric is washed in the acidic aqueous wash bath for from about 30 mins to about 3 hours.

5. A method according to claim 1, wherein step (b) is carried out with an acidic aqueous wash bath temperature of about 5° C. to about 25° C.

6. A method according to claim 1, wherein the acidic component is a polycarboxylic acid.

7. A method according to claim 1, wherein the acidic component is citric acid.

8. A method according to claim 1, wherein the detersive surfactant is selected from: alkyl benzene sulphonate, alkyl sulphate, alkoxylated alkyl sulphate, alkoxylated alcohol and any combination thereof.
